(19) United States
(12) Patent Application Publication
(10) Pub. No.: US 2026/0274713 A1
(43) Pub. Date: Sep. 17, 2026

(54) DEVICE BODY STRUCTURE AND WATER SURFACE CLEANING DEVICE

(71) Applicant: Shenzhen Maining Innovation Technology Co., Ltd., Shenzhen (CN)

(72) Inventor: Huifeng HUANG, Shenzhen (CN)

(73) Assignee: Shenzhen Maining Innovation Technology Co., Ltd., Shenzhen (CN)

(21) Appl. No.: 19/670,268

(22) Filed: May 7, 2026

(30) Foreign Application Priority Data
Mar. 25, 2026 (CN) 202620377971.6

(51) Int. Cl. C02F 1/40; B63H 21/17; C02F 1/00; C02F 103/42; E04H 4/12; H02S 20/30; H02S 40/38

(52) U.S. Cl. CPC C02F 1/40; B63H 21/17; C02F 1/008; E04H 4/1263; H02S 20/30; H02S 40/38; C02F 2103/42; C02F 2201/009

(57) ABSTRACT

A device body structure includes a main frame, a cover plate, a battery, and a main control board. The main frame includes a base body and side wing members connected to two sides of the base body. The cover plate is fastened to the main frame. A receiving space is formed inside the main frame. The battery and the main control board are arranged within the receiving space along a horizontal direction, and the battery is electrically connected to the main control board. The present application achieves that the battery and the main control board are arranged separately, eliminating the need to provide a deep groove for accommodating both components. Thus, the space utilization of the device body in the height direction is greatly improved, and the overall size of the device body is effectively reduced.

### CROSS-REFERENCE TO RELATED APPLICATIONS

This application claims priority to Chinese Patent Application No. 202620377971.6 with a filing date of Mar. 25, 2026. The content of the aforementioned application, including any intervening amendments thereto, is incorporated herein by reference.

### TECHNICAL FIELD

The present application belongs to the technical field of water surface devices, and particularly relates to a device body structure and a water surface cleaning device.

### BACKGROUND

As the demand for swimming pool cleaning continues to increase, manual cleaning methods are gradually being replaced by water surface cleaning robots for swimming pools. Such devices rely on propeller thrust to achieve autonomous cleaning, greatly improving cleaning efficiency.

In the device body structure design of an existing water surface cleaning device for a swimming pool, a battery and a main control board are generally integrated in the same sealed mounting cavity, and both share a single sealing structure. This approach has numerous technical drawbacks: First, when one of the components is damaged, the entire sealed cavity must be disassembled for repair, and the disassembly process can easily cause damage to the waterproof sealing structure, leading to water ingress and failure of the device. Consequently, the maintenance cost and the repair difficulty are high. Second, in the event of battery leakage, bulging, or thermal runaway, the battery can directly corrode and damage the adjacent main control board, easily causing short circuits and device failure, and even posing safety risks in severe cases. Third, the single sealed cavity requires a relatively deep accommodating groove to house both the battery and the main control board, resulting in low space utilization and uneven weight distribution. Accordingly, larger floating members are required to ensure the floating stability of the device.

### SUMMARY OF PRESENT INVENTION

Objectives of the present application are to overcome the existing drawbacks and provide a device body structure and a water surface cleaning device, where a battery and a main control board are arranged separately, thereby improving space utilization, optimizing weight distribution of a device body, while reducing maintenance difficulty and safety risks, and ensuring the sealing performance and use stability of the device.

To resolve the above technical problem, the present application provides the following technical solution.

A first objective of the present application is to provide a device body structure, applied to a water surface cleaning device and including a main frame, a cover plate, a battery, and a main control board;
the main frame includes a base body and side wing members connected to two sides of the base body;
the cover plate is fastened to the main frame; a receiving space is formed within the base body; the battery and the main control board are arranged within the receiving space along a horizontal direction; and the battery is electrically connected to the main control board.

Further, the receiving space includes a first accommodating groove that is formed by recessing the base body toward the cover plate; the main control board is arranged within the first accommodating groove; and the battery and the main control board are spaced apart on the base body along a direction of forward motion of the water surface cleaning device.

Further, the device body structure further includes a switch assembly and a sealing plate, where the main frame is provided with a second accommodating groove recessed toward the cover plate; the switch assembly is arranged within the second accommodating groove; and the sealing plate is configured to cover openings of the first accommodating groove and the second accommodating groove.

Further, the first accommodating groove is filled with a sealing glue for sealing the main control board.

Further, the device body structure further includes a solar panel that is mounted on an outer surface of the cover plate and electrically connected to the main control board.

Further, the device body structure further includes a plurality of floating members that are mounted on the side wing members on the two sides of the base body.

Further, the device body structure further includes a driving assembly, where a mounting cavity is formed between the two side wing members, and the driving assembly is arranged within the mounting cavity.

Further, the driving assembly includes a driving motor and a propeller; and the driving motor is electrically connected to the main control board and is connected to the propeller.

Another objective of the present application is to provide a water surface cleaning device, including the device body structure provided by the first objective of the present application and a debris basket, where a mounting cavity is formed within the main frame, and the debris basket is slidably snap-fitted into the mounting cavity.

In conjunction with the above technical solutions, compared with the prior art, the present application has the following beneficial effects:

The present application achieves that the battery and the main control board are arranged separately, eliminating the need to provide a deep groove for accommodating both components. Thus, the space utilization of the device body in the height direction is greatly improved, and the overall size of the device body is effectively reduced. Moreover, the front-rear weight distribution of the device body is optimized so that the device body can float more stably. The required size of floating members can be reduced, thereby lowering the overall material cost of the device.

The physical isolation between the battery and the main control board prevents direct corrosion and damage to the main control board in the event of battery leakage, bulging, or thermal runaway, thereby fundamentally reducing the probability of short circuits and device failures, improving the use safety of the device and prolonging the service life thereof.

The battery and the main control board are respectively disposed in independent mounting spaces. When one of the components is damaged, it can be separately disassembled and repaired without dismantling the entire sealing structure, thereby reducing maintenance difficulty and cost, and effectively avoiding the problems of sealing structure damage and device water ingress and failure caused by overall disassembly.

The first accommodating groove is filled with a sealing glue, and the sealing plate is employed to cover and seal the first accommodating groove and the second accommodating groove as a whole. The switch assembly and the main control board are separately sealed before being uniformly protected, thereby enhancing the sealing and waterproof performance of the circuit components and further ensuring the operational stability of the device in water.

The solar panel is disposed on the outer surface of the cover plate, and can achieve solar-assisted power supply, increasing the runtime of the device and enabling it to adapt to long-duration cleaning operations in scenarios such as swimming pools. The reasonable arrangement of the driving assembly and the floating members further ensures the traveling stability and floating balance of the device.

### BRIEF DESCRIPTION OF THE DRAWINGS

The accompanying drawings are provided for further comprehension of the present application and constitute a part of the specification. The accompanying drawings, together with the embodiments of the present application, are intended to explain rather than limit the present application. In the accompanying drawings:

FIG. 1 is an exploded diagram showing a device body structure according to an embodiment of the present application;

FIG. 2 is an exploded diagram showing a battery and a main frame according to an embodiment of the present application;

FIG. 3 is an exploded diagram showing a main control board and a device body according to an embodiment of the present application;

FIG. 4 is a schematic structural diagram showing a second accommodating groove according to an embodiment of the present application; and

FIG. 5 is a schematic structural diagram showing a water surface cleaning device according to an embodiment of the present application.

List of Reference Numerals: 1—main frame; 101—base body; 102—side wing member; 2—cover plate; 3—solar panel; 4—floating member; 5—battery; 6—main control board; 7—sealing plate; 8—switch assembly; 9—driving assembly; 901—driving motor; 902—propeller; 10—receiving space; 11—first accommodating groove; 12—second accommodating groove; 100—device body; 1001—mounting cavity; and 200—debris basket.

### DETAILED DESCRIPTION OF THE EMBODIMENTS

The preferred embodiments of the present application are described below with reference to the accompanying drawings. It should be understood that the preferred embodiments described herein are only used to illustrate and explain the present application, rather than to limit the present application.

### Embodiment 1

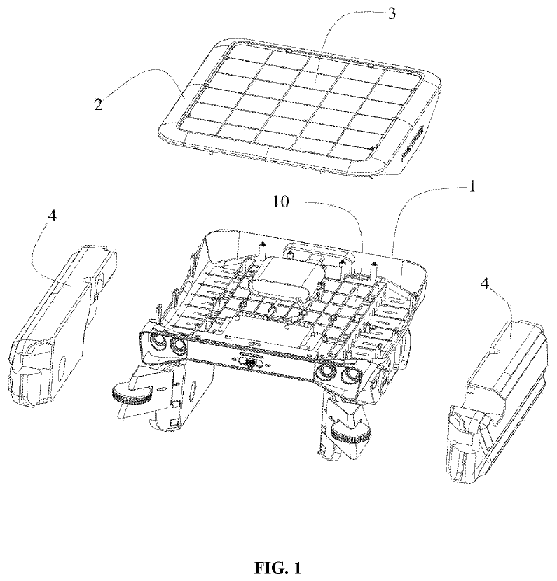

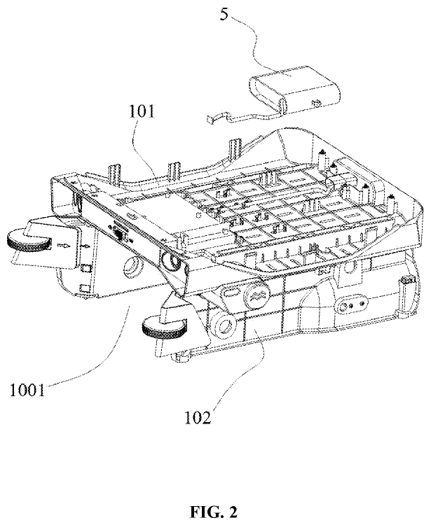

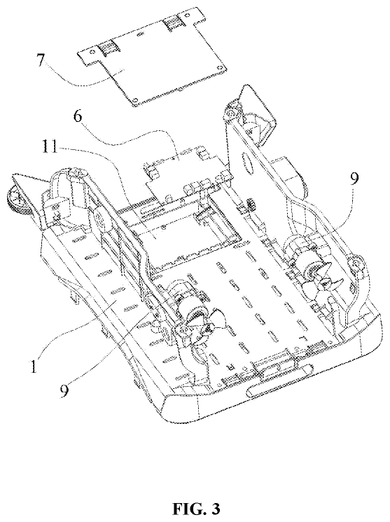

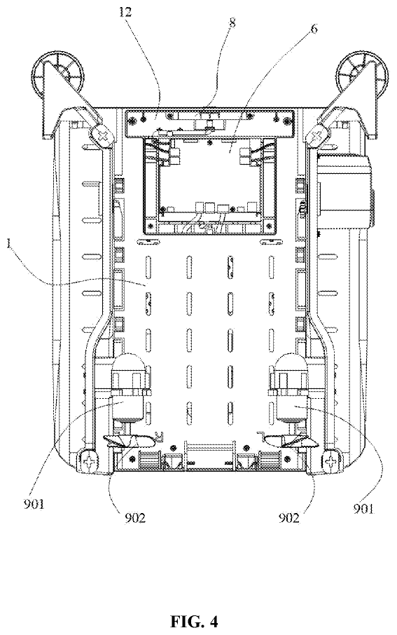

FIG. 1 to FIG. 4 illustrate an embodiment of a device body structure provided by the present application. The device body structure may be applied to a water surface cleaning device, and includes a main frame 1, a cover plate 2, a solar panel 3, a floating member 4, a battery 5, a main control board 6, a switch assembly 8, and a driving assembly 9.

The main frame 1 includes a base body 101 and side wing members 102 connected to two sides of the base body 101. The cover plate 2 is fastened to the main frame 1. A receiving space 10 is formed within the base body 101. The battery 5 and the main control board 6 are arranged within the receiving space 10 along a horizontal direction, and the battery 5 is electrically connected to the main control board 6. The solar panel 3 is mounted on an outer surface of the cover plate 2 and electrically connected to the main control board 6. A plurality of floating members 4 are mounted on the side wing members 102 on the two sides of the base body 101 to ensure the floating stability of the device on the water surface. A mounting cavity 1001 is formed between the two side wing members 102, and the driving assembly 9 is arranged within the mounting cavity 1001. The driving assembly 9 includes a driving motor 901 and a propeller 902. The driving motor 901 is electrically connected to the main control board 6. An output shaft of the driving motor 901 is connected to the propeller 902. The driving assembly 9 adopts a propeller propulsion structure to provide power for the travel of the device body, thereby enabling autonomous movement of the device.

Preferably, the receiving space 10 includes a first accommodating groove 11 that is formed by recessing the base body 101 toward the cover plate 2. The main control board 6 is arranged within the first accommodating groove 11. The battery 5 and the main control board 6 are spaced apart on the base body 101 along a direction of forward motion of the water surface cleaning device. In this way, full utilization of both in the same vertical space is achieved.

It should be noted that the purpose of this embodiment is to arrange the battery 5 and the main control board 6 in parallel and space them apart from each other, thereby fully utilizing the receiving space 10 within the main frame 1. Therefore, in addition to the arrangement of the battery 5 and the main control board 6 as described in the above embodiment, the battery 5 may alternatively be disposed within the first accommodating groove 11. In this way, the purpose of fully utilizing the receiving space 10 within the main frame 1 is also achieved, effectively reducing the overall size of the device body. Moreover, the front-rear weight distribution of the device body is optimized so that the device body can float more stably. This is not specifically limited in the present application.

It will be understood that the receiving space 10 in this embodiment is defined by a thickness of the base body 101 in a height direction. In addition to the illustrated embodiment, the receiving space 10 may alternatively be configured as an integral space formed by recessing a top surface of the base body 101 toward the water surface, and the battery 5 and the main control board 6 are arranged in parallel within the receiving space 10. Alternatively, the receiving space 10 is formed by recessing a bottom surface of the base body 101 toward the cover plate 2, and the battery 5 and the main control board 6 are arranged in parallel within the receiving space 10. These embodiments are also within the protection scope of the present application.

Further, the main frame 1 is provided with a second accommodating groove 12 recessed toward the cover plate 2. The switch assembly 8 is arranged within the second accommodating groove 12. The sealing plate 7 is configured to cover openings of the first accommodating groove 11 and the second accommodating groove 12.

In this embodiment of the present application, during assembling, the battery 5 is first placed into the receiving space 10 of the main frame 1. Then, the main control board 6 and the switch assembly 8 are inserted into the first accommodating groove 11 and the second accommodating groove 12, respectively. The first accommodating groove 11 is filled with a sealing glue, and after the sealing glue has cured, the sealing plate 7 is placed thereon. Subsequently, the floating members 4 and the driving assembly 9 are mounted at corresponding positions on the main frame 1. After the solar panel 3 is mounted on the cover plate 2, the cover plate 2 is fastened to the main frame 1, thereby completing the assembling of the device body structure.

### Embodiment 2

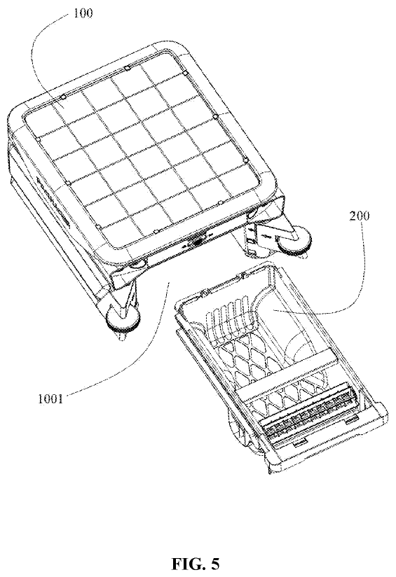

As shown in FIG. 5, this embodiment of the present application provides a water surface cleaning device including a device body 100 and a debris basket 200. The device body 100 employs the device body structure provided in Embodiment 1. A mounting cavity 1001 is formed within the main frame 1, and the debris basket 200 is adaptively snap-fitted into the mounting cavity 1001.

During the traveling of the device, debris on the water surface can be smoothly guided into the debris basket 200 for collection. The debris basket 200 is detachably connected to the mounting cavity 1001, facilitating subsequent debris removal and cleaning of the debris basket 200.

Finally, it should be noted that the above descriptions are only preferred embodiments of the present application, and are not intended to limit the present application. Although the present application has been described in detail with reference to the foregoing embodiments, those skilled in the art may still modify the technical solutions described in the foregoing embodiments, or equivalently substitute some technical features thereof. Any modifications, equivalents, improvements, and the like, made within the spirit and principle of the present application shall all fall within the protection scope of the present application.

What is claimed is:

1. A device body structure, applicable to a water surface cleaning device and comprising: a main frame (1), a cover plate (2), a battery (5), and a main control board (6);
wherein the main frame (1) comprises a base body (101) and side wing members (102) connected to two sides of the base body (101); and
the cover plate (2) is fastened to the main frame (1); a receiving space (10) is formed within the base body (101); the battery (5) and the main control board (6) are arranged within the receiving space (10) along a horizontal direction; and the battery (5) is electrically connected to the main control board (6).

2. The device body structure according to claim 1, wherein the receiving space (10) comprises a first accommodating groove (11) that is formed by recessing the base body (101) toward the cover plate (2); and
the main control board (6) is arranged within the first accommodating groove (11); and the battery (5) and the main control board (6) are spaced apart on the base body (101) along a direction of forward motion of the water surface cleaning device.

3. The device body structure according to claim 2, further comprising a switch assembly (8) and a sealing plate (7), wherein the main frame (1) is provided with a second accommodating groove (12) recessed toward the cover plate (2); the switch assembly (8) is arranged within the second accommodating groove (12); and the sealing plate (7) is configured to cover openings of the first accommodating groove (11) and the second accommodating groove (12).

4. The device body structure according to claim 2, wherein the first accommodating groove (11) is filled with a sealing glue for sealing the main control board (6).

5. The device body structure according to claim 1, further comprising a solar panel (3) mounted on an outer surface of the cover plate (2) and electrically connected to the main control board (6).

6. The device body structure according to claim 1, further comprising a plurality of floating members (4) mounted on the side wing members (102) on the two sides of the base body (101).

7. The device body structure according to claim 1, further comprising a driving assembly (9), wherein a mounting cavity (1001) is formed between the two side wing members (102), and the driving assembly (9) is arranged within the mounting cavity (1001).

8. The device body structure according to claim 7, wherein the driving assembly (9) comprises a driving motor (901) and a propeller (902); and the driving motor (901) is electrically connected to the main control board (6) and the driving motor (901) is connected to the propeller (902).

9. A water surface cleaning device, comprising: the device body structure according to claim 1 and a debris basket (200), wherein a mounting cavity (1001) is formed within the main frame (1), and the debris basket (200) is slidably snap-fitted into the mounting cavity (1001).
